(19) United States
(12) Patent Application Publication
(10) Pub. No.: US 2014/0006550 A1
(43) Pub. Date: Jan. 2, 2014

(54) SYSTEM FOR ADAPTIVE DELIVERY OF CONTEXT-BASED MEDIA

(71) Applicants: Gamil A. Cain, El Dorado Hills, CA (US); Matthew D. Coakley, Hillsboro, OR (US); Rajiv K. Mongia, Redwood City, CA (US); Cynthia E. Kaschub, Portland, OR (US); Anna-Marie Mansour, Hillsboro, OR (US)

(72) Inventors: Gamil A. Cain, El Dorado Hills, CA (US); Matthew D. Coakley, Hillsboro, OR (US); Rajiv K. Mongia, Redwood City, CA (US); Cynthia E. Kaschub, Portland, OR (US); Anna-Marie Mansour, Hillsboro, OR (US)

(21) Appl. No.: 13/539,372

(22) Filed: Jun. 30, 2012

(51) Int. Cl. H04L 29/08

(52) U.S. Cl. CPC H04L 67/10
USPC 709/217

(57) ABSTRACT

A system and method for adaptive delivery of media to one or more users in an environment based on contextual characteristics of the environment and the one or more users within. The system includes a media delivery system configured to receive and process data captured by one or more sensors positioned within the environment and determine contextual characteristics of the environment based on the captured data. The contextual characteristics may include, but are not limited to, identities of one or more users, subject matter of communication between the users, physical motion, including gestures, of one or more users and objects within the environment.

### FIELD

The present disclosure relates to delivery of media, and, more particularly, to a system and method for adaptive delivery of media to one or more users in an environment based on contextual characteristics of the environment and the one or more users within.

### BACKGROUND

Certain environments may allow for interaction among one or more persons. For example, some spaces may promote interaction (e.g. communication) between persons in that space (hereinafter referred to as “conversational spaces”). Conversational spaces may generally include, for example, a living room of a person's home, waiting rooms, lobbies of hotels and/or office buildings, etc. where one or more persons may congregate and interact with one another. Conversational spaces may include various forms of media (e.g. magazines, books, music, televisions, etc.) which may provide entertainment to one or more persons and may also foster interaction between persons.

With the continual growth of digital forms of media, conversational spaces may contain less physical media available to persons. If, during an active conversation, a person would like refer to media having content related to the conversation (e.g. show a news article having subject matter related to content of the conversation), a person may have to manually engage a media device (e.g. laptop, smartphone, tablet, etc.) in order to obtain such media and related content. This may be a form of frustration and/or annoyance for all persons involved in the conversation and may interrupt the flow of the conversation.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a block diagram illustrating one embodiment of a system for adaptive delivery of media to one or more users in an environment based on contextual characteristics consistent with various embodiments of the present disclosure;

FIG. 2 is a block diagram illustrating a portion of the system of FIG. 1 in greater detail;

FIG. 3 is a block diagram illustrating another portion of the system of FIG. 1 in greater detail;

FIG. 4 is a depiction of an environment having multiple users within and interacting with one another illustrating one embodiment of a system consistent with various embodiments of the present disclosure;

FIG. 5 is a flow diagram illustrating one embodiment for adaptive delivery of media in accordance with at least one embodiment of the present disclosure.

Although the following Detailed Description will proceed with reference being made to illustrative embodiments, many alternatives, modifications, and variations thereof will be apparent to those skilled in the art.

### DETAILED DESCRIPTION

By way of overview, the present disclosure is generally directed to a system and method for adaptive delivery of media to one or more users in an environment based on contextual characteristics of the environment and the one or more users within. The system includes a media delivery system configured to receive and process data captured by one or more sensors positioned within the environment and determine contextual characteristics of the environment based on the captured data. The contextual characteristics may include, but are not limited to, identities of one or more users, physical motion, including gestures, of one or more users, objects within the environment and subject matter of communication between the users.

The media delivery system is further configured to identify media from a media source for presentation on one or more media devices within the environment based, at least in part, on the contextual characteristics of the environment. The identified media includes content related to the contextual characteristics of the environment. The media delivery system may further be configured to allow one or more users to interact with the identified media presented on the one or more media devices.

A system consistent with the present disclosure provides an automatic and intuitive means of delivering relevant media to one or more users in an environment based on contextual characteristics of the environment, including recognized content of a conversation between the users. The system may be configured to continually monitor contextual characteristics of the environment so as to adaptively deliver media having relevant content in real-time or near real-time to users in the environment. Accordingly, the system may promote enhanced interaction and foster further communication between the users.

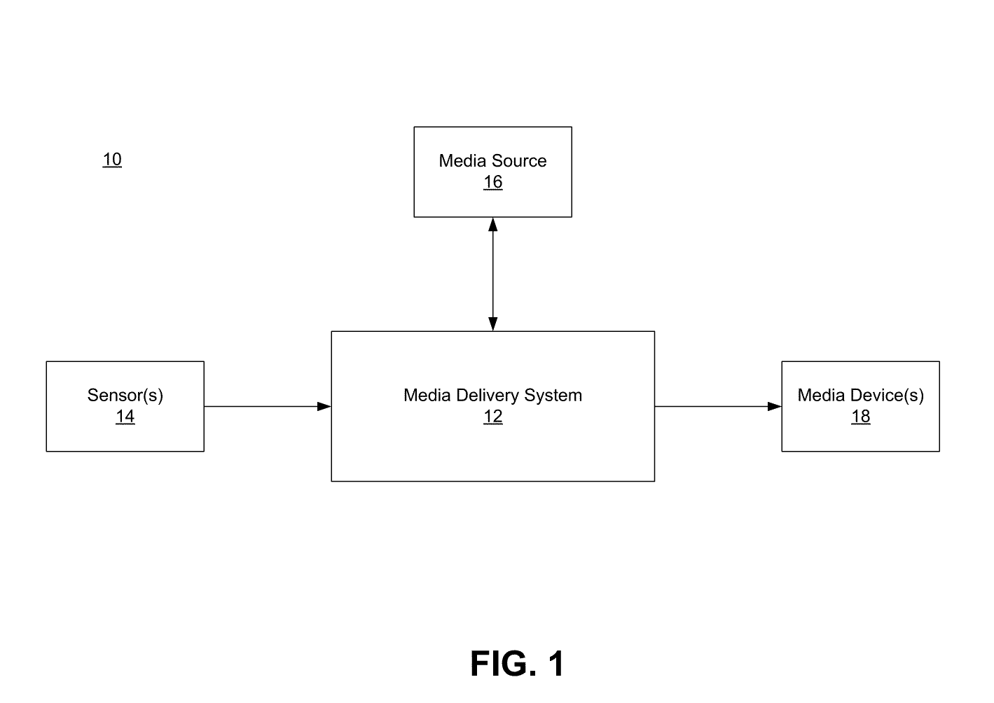

Turning to FIG. 1, one embodiment of a system 10 consistent with the present disclosure is generally illustrated. The system 10 includes a media delivery system 12, at least one sensor 14, a media source 16 and at least one media device 18. As discussed in greater detail herein, the media delivery system 12 is configured to receive data captured from the at least one sensor 14 and identify at least one contextual characteristic of an environment having one or more users within based on the captured data. The term “environment” may refer to a space where the one or more persons (e.g. users) may congregate and interact with one another, such as, for example, common rooms of a home (e.g. living room, family room, kitchen etc.), waiting rooms, lobbies of hotels and office buildings, etc. The contextual characteristics may include, but are not limited to, identities of one or more users, physical motion, including gestures, of one or more users, objects within the environment and subject matter of communication between the users.

The media delivery system 12 is further configured to communicate with a media source 16 and search media on said media source 16 for content related to the at least one contextual characteristic. Upon identifying media content related to the at least one contextual characteristic, the media delivery system 12 is further configured to transmit the relevant media content to at least one media device 18 for presentation to one or more users within the environment. The media delivery system 12 may further be configured to allow the one or more users to interact with the relevant media content presented on the media device 18.

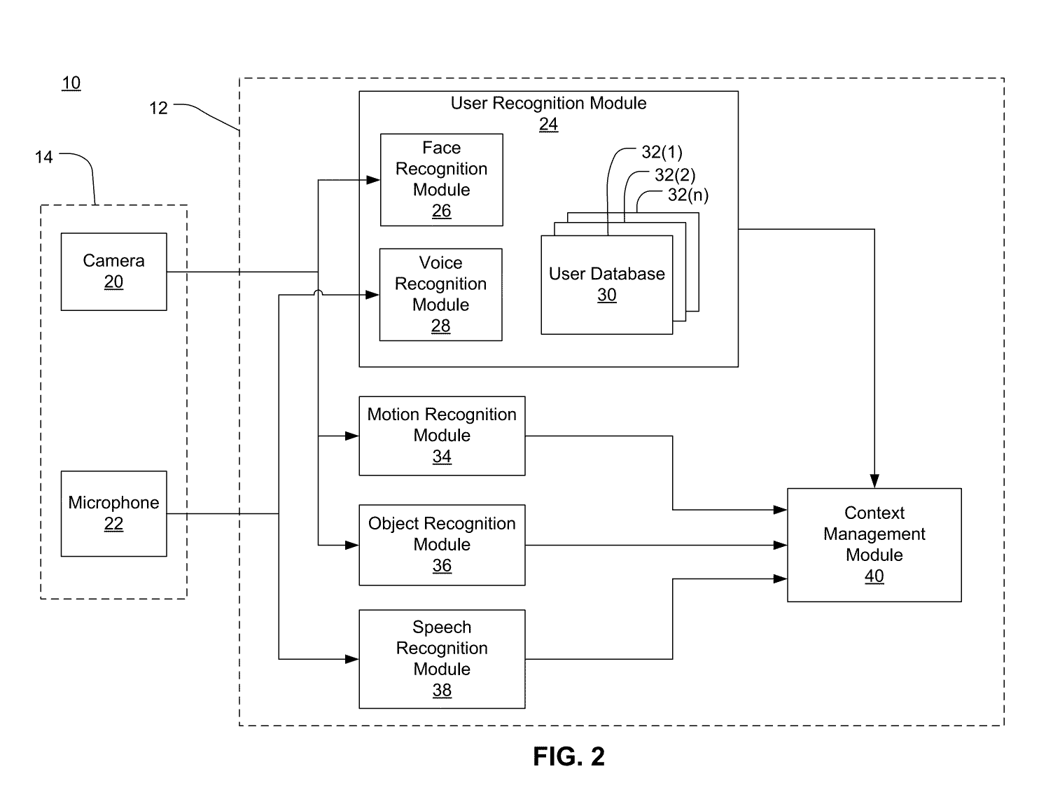

Turning now to FIG. 2, a portion of the system 10 of FIG. 1 is illustrated in greater detail. As previously described, the media delivery system 12 is configured to receive data captured from at least one sensor 14. As shown, the system 10 may include a variety of sensors configured to capture data related to various characteristics of the environment and the users within, such as visual characteristics and/or audible characteristics. For example, in the illustrated embodiment, the system 10 includes at least one camera 20 configured to capture images of the environment and one or more users within and at least one microphone 22 configured to capture sound data of the environment, including voice data of the one or more users. The microphone 22 may further be configured to capture ambient noise from the environment, as described in greater detail herein.

The media delivery system 12 may further include recognition modules 24, 26, 28, 34, 36 and 38, wherein each of the recognition modules is configured to receive data captured by at least one of the sensors and establish contextual characteristics associated with the environment and the users within based on the captured data, which is described in greater detail herein.

In the illustrated embodiment, the media delivery system 12 includes a user recognition module 24, motion recognition module 34, object recognition module 36 and a speech recognition module 38. The user recognition module 24 is configured to receive one or more digital images captured by the at least one camera 20 and voice data from one or more users within the environment captured by the at least one microphone 22. The user recognition module 24 is further configured to analyze the images and voice data and identify one or more users based on image and voice data analysis.

As shown, the user recognition module 24 includes a face recognition module 26 and a voice recognition module 28. The face recognition module 26 is configured to receive one or more digital images captured by the at least one camera 20. The camera 20 includes any device (known or later discovered) for capturing digital images representative of an environment that includes one or more persons, and may have adequate resolution for face analysis of the one or more persons in the environment as described herein.

For example, the camera 20 may include a still camera (i.e., a camera configured to capture still photographs) or a video camera (i.e., a camera configured to capture a plurality of moving images in a plurality of frames). The camera 20 may be configured to capture images in the visible spectrum or with other portions of the electromagnetic spectrum (e.g., but not limited to, the infrared spectrum, ultraviolet spectrum, etc.). It should be noted that the camera 20 may be incorporated within the media delivery system 12 or media device 18 or may be a separate device configured to communicate with the media delivery system 12 and/or media device 18 via any known wired or wireless communication. The camera 20 may include, for example, a web camera (as may be associated with a personal computer and/or TV monitor), handheld device camera (e.g., cell phone camera, smart phone camera (e.g., camera associated with the iPhone®, Trio®, Blackberry®, etc.), laptop computer camera, tablet computer (e.g., but not limited to, iPad®, Galaxy Tab®, and the like), e-book reader (e.g., but not limited to, Kindle®, Nook®, and the like), etc.

In one embodiment, the system 10 may include a single camera 20 within the environment positioned in a desired location, such as, for example, adjacent the media device 18 and configured to capture images of the environment and the users within the environment within close proximity to the media device 18. In other embodiments, the system may include multiple cameras 20 positioned in various locations in the environment, wherein each camera 20 is configured to capture images of the associated location, including all users within the associated location.

Upon receiving the image(s) from the camera 20, the face recognition module 26 may be configured to identify a face and/or face region within the image(s) and determine one or more characteristics of the users captured in the image(s). As generally understood by one of ordinary skill in the art, the face recognition module 26 may be configured to use any known internal biometric modeling and/or analyzing methodology to identify face and/or face region with the image(s). For example, the face recognition module 26 may include custom, proprietary, known and/or after-developed face recognition and facial characteristics code (or instruction sets), hardware, and/or firmware that are generally well-defined and operable to receive a standard format image and identify, at least to a certain extent, a face and one or more facial characteristics in the image. Additionally, the face recognition module 26 may be configured to identify a face and/or facial characteristics of a user by extracting landmarks or features from the image of the user's face. For example, the face recognition module 26 may analyze the relative position, size, and/or shape of the eyes, nose, cheekbones, and jaw, for example, to form a facial pattern.

Upon identifying facial characteristics and/or patterns of one or more users within the environment, the face recognition module 26 may be configured to compare the identified facial patterns to user models 32(1)-32(n) of a user database 30 to establish potential matches of the user(s) in the image(s). In particular, each user model 32(1)-32(n) includes identifying data of the associated user. For example, in the case of the face recognition module 26, each user model 32 includes identified facial characteristics and/or patterns of an associated user.

The face recognition module 26 may use identified facial patterns of a user to search the user models 32(1)-32(n) for images with matching facial patterns. In particular, the face recognition module 26 may be configured to compare the identified facial patterns with images stored in the user models 32(1)-32(n). The comparison may be based on template matching techniques applied to a set of salient facial features. Such known face recognition systems may be based on, but are not limited to, geometric techniques (which looks at distinguishing features) and/or photometric techniques (which is a statistical approach that distill an image into values and comparing the values with templates to eliminate variances). In the event that a match is not found, the face recognition module 26 may be configured to create a new user model 32 including the identified facial patterns of the image(s), such that on future episodes of monitoring the environment, the user may be identified.

The voice recognition module 28 is configured to receive voice data from one or more users within the environment captured by the at least one microphone 22. The microphone 22 includes any device (known or later discovered) for capturing voice data of one or more persons, and may have adequate digital resolution for voice analysis of the one or more persons. It should be noted that the microphone may be incorporated within the media delivery system 12 or media device 18 or may be a separate device configured to communicate with the media delivery system 12 and/or media device 18 via any known wired or wireless communication.

In one embodiment, the system 10 may include a single microphone 22 configured to capture voice data including all users in the environment. In other embodiments, the system 10 may include multiple microphones positioned throughout the environment, wherein some microphones may be adjacent one or more associated media devices 18 and may be configured to capture voice data of one or more users proximate to the associated media device 18. For example, the system 10 may include multiple media devices 18, wherein each media device 18 may have a microphone 22 positioned adjacent thereto, such that each microphone 22 may capture voice data of one or more users in close proximity to the associated media device 18.

Upon receiving the voice data from the microphone 22, the voice recognition module 28 may be configured to identify a voice of one or more users. As generally understood by one of ordinary skill in the art, the voice recognition module 28 may be configured to use any known voice analyzing methodology to identify particular voice pattern with the voice data. For example, the voice recognition module 28 may include custom, proprietary, known and/or after-developed voice recognition and characteristics code (or instruction sets), hardware, and/or firmware that are generally well-defined and operable to receive voice data and identify a voice and one or more voice characteristics. It should be noted that the microphone 22 may provide improved means of allowing the voice recognition module 28 to identify and extract voice input from ambient noise. For example, the microphone 22 may include a microphone array. Other known noise isolation techniques as generally understood by one skilled the art may be included in a system 10 consistent with the present disclosure.

Upon identifying voice patterns of one or more users, the voice recognition module 28 may be configured to compare the identified voice patterns to the user models 32(1)-32(n) of the user database 30 to establish potential matches of the user(s), either alone or in combination with the analysis of the face recognition module 26. In particular, each user model 32(1)-32(n) includes identifying data of the associated user. For example, in the case of the voice recognition module 28, each user model 32 includes identified voice characteristics and/or patterns of an associated user.

The voice recognition module 28 may use identified voice patterns of a user to search the user models 32(1)-32(n) for voice data with matching voice characteristics and/or patterns. In particular, the voice recognition module 28 may be configured to compare the identified voice patterns with voice data stored in the user models 32(1)-32(n). In the event that a match is not found, the voice recognition module 28 may be configured to create a new user model 32 including the identified voice patterns of the voice data, such that on future episodes of monitoring the environment, the user may be identified.

In addition to determining the identity of one or more users in the environment, the media delivery system 12 further includes a motion recognition module 30 configured to receive and analyze one or more digital images captured by the at least one camera 20 and determine one or more gestures of one or more users based image analysis. As generally understood by one of ordinary skill in the art, the motion recognition module 30 may be configured to use any known internal biometric modeling and/or analyzing methodology to identify hand and/or hand region with the image(s). For example, the motion recognition module 30 may include custom, proprietary, known and/or after-developed hand recognition and hand characteristics code (or instruction sets), hardware, and/or firmware that are generally well-defined and operable to receive a standard format image and identify, at least to a certain extent, a hand and one or more hand characteristics in the image.

For example, the motion recognition module 34 may be configured to detect and identify, for example, hand characteristics of a user through a series of images (e.g., video frames at 24 frames per second). For example, the motion recognition module 34 may include custom, proprietary, known and/or after-developed hand tracking code (or instruction sets) that are generally well-defined and operable to receive a series of images (e.g., but not limited to, RGB color images), and track, at least to a certain extent, a hand in the series of images. The motion recognition module 34 may further include custom, proprietary, known and/or after-developed hand shape code (or instruction sets) that are generally well-defined and operable to identify one or more shape features of the hand and identify a hand gesture in the image. As generally understood by one skilled in the art, the media delivery system 12 may be controlled by one or more users via hand gestures.

In addition, the motion recognition module 34 may be configured, either alone or in combination with the voice recognition module 28, to provide data related to detected motion of any users and/or objects within the environment for the controlling of power states of the system 10. More specifically, the system 10 may be configured to provide a means of transitioning from an active state (e.g. continual monitoring and identification of contextual characteristics of the environment and users within and presentation of media content based on contextual characteristics) and an inactive (e.g. low power) state (e.g. monitoring of environment and deactivating presentation of media content when no users are present). For example, the amount of motion detected by the motion recognition module 34 and the amount of noise detected by the voice recognition module 28 in an environment may be used in the determination of transitioning the system 10 between active and inactive power states. It should be noted that the motion recognition module 38 and voice recognition module 28 may be configured to operate in the inactive power state.

The media delivery system 12 further includes an object recognition module 36 configured to receive and analyze one or more digital images captured by the at least one camera 20 and determine one or more objects within the image. More specifically, the object recognition module 36 may include custom, proprietary, known and/or after-developed object detection and identification code (or instruction sets) that are generally well-defined and operable to detect one or more objects within an image and identify the object based on shape features of the object. As described in greater detail herein, the media delivery system 12 may be configured to identify media having content related to one or more objects identified by the object recognition module 36 for presentation to the users within the environment. For example, users may be presented with relevant media content having information corresponding to the identified object, such as, for example, displaying advertisements for the identified object, display similar objects, display video augmenting the identified object within (e.g., a user holding a toy (e.g. Elmo) and the display presents an image of background information (Sesame Street neighborhood) related to the toy).

The media delivery system 12 further includes a speech recognition module 38 configured to receive voice data from one or more users captured by the at least one microphone 22. Upon receiving the voice data from the microphone 22, the speech recognition module 38 may be configured to use any known speech analyzing methodology to identify particular subject matter of the voice data. For example, the speech recognition module 38 may include custom, proprietary, known and/or after-developed speech recognition and characteristics code (or instruction sets), hardware, and/or firmware that are generally well-defined and operable to receive voice data and translate speech into text data. The speech recognition module 38 may be configured to receive voice data related to a conversation between users, wherein the speech recognition module 38 may be configured to identify one or more keywords indicative of the subject matter of the conversation. Additionally, the speech recognition module 38 may be configured to identify one or more spoken commands from one or more users to control the media delivery system 12, as generally understood by one skilled in the art.

Additionally, the speech recognition module 38 may be configured to detect and extract ambient noise from the voice data captured by the microphone 22. The speech recognition module 38 may include custom, proprietary, known and/or after-developed noise recognition and characteristics code (or instruction sets), hardware, and/or firmware that are generally well-defined and operable to decipher ambient noise of the voice data and identify subject matter of the ambient noise, such as, for example, identifying subject matter of audio and/or video content (e.g., music, movies, television, etc.) being presented. For example, the speech recognition module 38 may be configured to identify music playing in the environment (e.g., identify lyrics to a song), movies playing in the environment (e.g., identify lines of movie), television shows, television broadcasts, etc.

In turn, the media delivery system 12 may be configured to identify media having content related to the identified subject matter of the ambient noise for presentation to the users within the environment. For example, users may be presented with lyrics of the song currently playing in the background, or statistics of players currently playing in the football game being watched, etc.

The media delivery system 12 further includes a context management module 40 configured to receive data from each of the recognition modules (24, 34, 36 and 38). More specifically, the recognition modules may provide the contextual characteristics of the environment and users within to the context management module 40. For example, the user recognition module 24 may provide data related to identities of one or more users and the motion recognition module 34 may provide data related to detected gestures of one or more users. Additionally, the objection recognition module 36 may provide data related to recognized objects within the environment and the speech recognition module 38 may provide data related to subject matter of one or more conversations among users in the environment.

In the event that the system 10 includes multiple cameras 20 and microphones 22 and associated recognition modules (24, 34, 36, 38) positioned within or adjacent to associated media devices 18, the context management module 40 may be configured to determine the associated media device 18 in which contextual characteristics are related to.

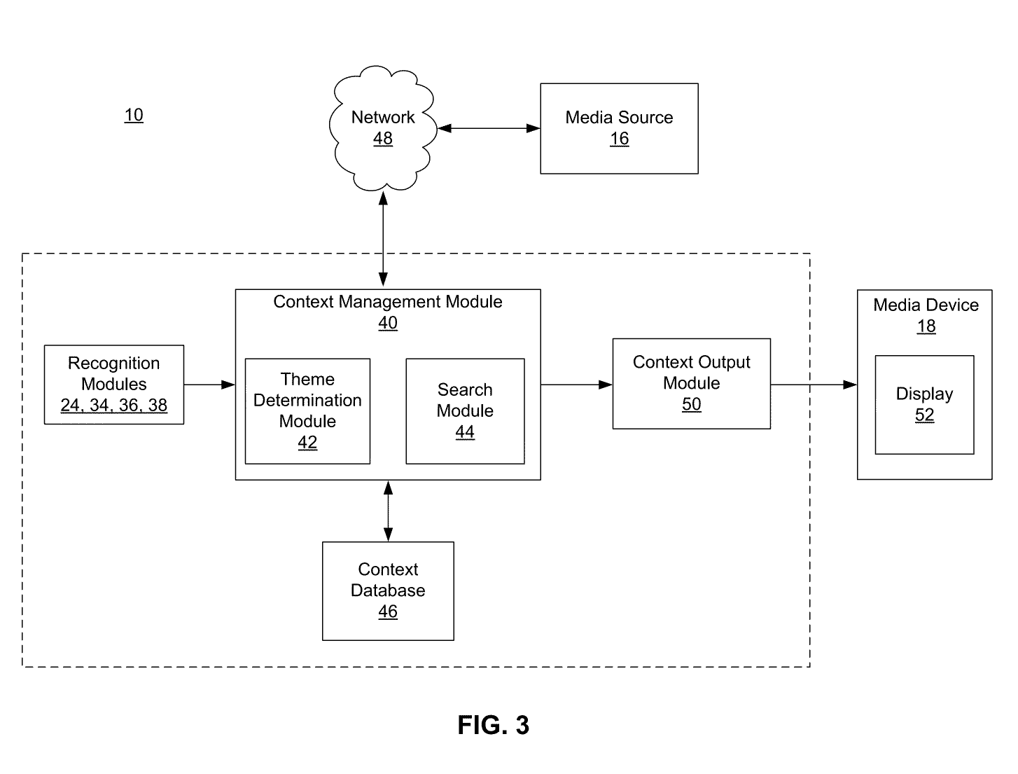

As shown in FIG. 3, the context management module 40 may include a theme determination module 42 and a search module 44. Generally, theme determination module 42 may be configured to analyze the contextual characteristics from the recognition modules (24, 34, 36, 38) and determine an overall theme (topic) of an activity of one or more users within the environment based on the contextual characteristics. For example, an activity may include a single user's activity within and/or interaction with the environment (e.g., but not limited to, playing with a toy). The activity may also include multiple users activities within the environment including interaction (e.g. conversations) with one another. For example, the theme determination module 42 may be configured to analyze data received from at least one of the recognition modules (24, 34, 36, 38) and determine a theme based on the analysis of data. Upon analyzing the data related to contextual characteristics, the context management module 40 may be configured to store the data in a context database 46. The context database 46 may include one or more profiles corresponding to each contextual characteristic (e.g. user identities, objects, gestures, subject matter of speech, etc.).

Upon establishment of an overall theme by the theme determination module 42, the context management module 40 may be configured to communicate with the media source 16 and search for media having content related to the overall theme. As shown, the context management module 40 may communicate with the media source 16 via a network 48. It should be noted, however, that the media source 16 may be a local, and, as such, the context management module 40 and media source 16 may communicate with one another via any known wired or wireless communication protocols.

Network 48 may be any network that carries data. Non-limiting examples of suitable networks that may be used as network 48 include the internet, private networks, virtual private networks (VPN), public switch telephone networks (PSTN), integrated services digital networks (ISDN), digital subscriber link networks (DSL), wireless data networks (e.g., cellular phone networks), other networks capable of carrying data, and combinations thereof. In some embodiments, network 48 is chosen from the internet, at least one wireless network, at least one cellular telephone network, and combinations thereof. Without limitation, network 48 is preferably the internet.

The media source 16 may be any source of media having content configured to presented to one or more users of the environment via the media device 18. In the illustrated embodiment, sources include, but are not limited to, public and private websites, social networking websites, audio and/or video websites, weather centers, news and other media outlets, combinations thereof, and the like.

It should also be noted that the media source 16 may include local sources of media, including, but not limited to, a selectable variety of consumer electronic devices, including, but not limited to, a personal computer (PC), tablet, notebook, smartphone, a video cassette recorder (VCR), a compact disk/digital video disk device (CD/DVD device), a cable decoder that receives a cable TV signal, a satellite decoder that receives a satellite dish signal, and/or a media server configured to store and provide various types of selectable programming. For example, the media source 16 may include local devices that one or more users within the environment possess.

In the illustrated embodiment, the search module 44 may be configured to search the media source 16 for media having content related to at least the overall theme of an activity of one or more users within the environment. In some embodiments, the search module 44 may be configured to search the media source 16 for media having content related to each of the contextual characteristics stored within the context database 46. As generally understood, the search module 44 may include custom, proprietary, known and/or after-developed search and recognition code (or instruction sets), hardware, and/or firmware that are generally well-defined and operable to generate a search query related to the overall theme and search the media source 16 and identify media content from the media source 16 corresponding to the search query and overall theme. For example, the search module 44 may include a search engine. As may be appreciated, the search module 44 may include other known searching components.

Upon identification of media having content related to one or more of the contextual characteristics contributing to the overall theme, the context management module 40 is configured to receive (e.g. download, stream, etc.) the relevant media content. The context management module 40 may further be configured to append one or more profile entries of the context database 46 with indexes to the relevant media content. More specifically, the context management module 40 is configured to aggregate the contextual characteristics recognized by each of the recognition modules (24, 34, 36, 38) with relevant media content from the media source 16.

The context management module 40 is further configured to transmit data related to the relevant media content from the media source 16 to a context output module 50 for presentation on the media device 18. The context output module 50 may be configured to provide processing (if necessary) and transmission of the relevant media content to the media device 18, such that the media device 18 may present the relevant media content to the users. For example, the context output module 50 may be configured to perform various forms of data processing, including, but not limited to, data conversion, data compression, data rendering and data transformation. As generally understood, the context output module 50 may include any known software and/or hardware configured to perform audio and/or video processing (e.g. compression, conversion, rendering, transformation, etc.).

The context output module 50 may be configured to wirelessly communicate (e.g. transmit and receive signals) with the media device 18 via any known wireless transmission protocol. For example, the context output module 50 may include WiFi enabled hardware, permitting wireless communication according to one of the most recently published versions of the IEEE 802.11 standards as of June 2012. Other wireless network protocols standards could also be used, either in alternative to the identified protocols or in addition to the identified protocol. Other network standards may include Bluetooth, an infrared transmission protocol, or wireless transmission protocols with other specifications (e.g., but not limited to, Wide Area Networks (WANs), Local Area Networks (LANs), etc.).

Upon receiving the relevant media content from the context output module 50, the media device 18 may be configured to present the relevant media content to one or more users in the environment. The relevant media content may include any type of digital media presentable on the media device 18, such as, for example, images, video content (e.g., movies, television shows) audio content (e.g. music), e-book content, software applications, gaming applications, etc. The media content may be presented to the viewer visually and/or aurally on the media device 18, via a display 52 and/or speakers (not shown), for example. The media device 18 may include any type of display 52 including, but not limited to, a television, an electronic billboard, a digital signage, a personal computer (e.g., desktop, laptop, netbook, tablet, etc.), e-book, a mobile phone (e.g., a smart phone or the like), a music player, or the like.

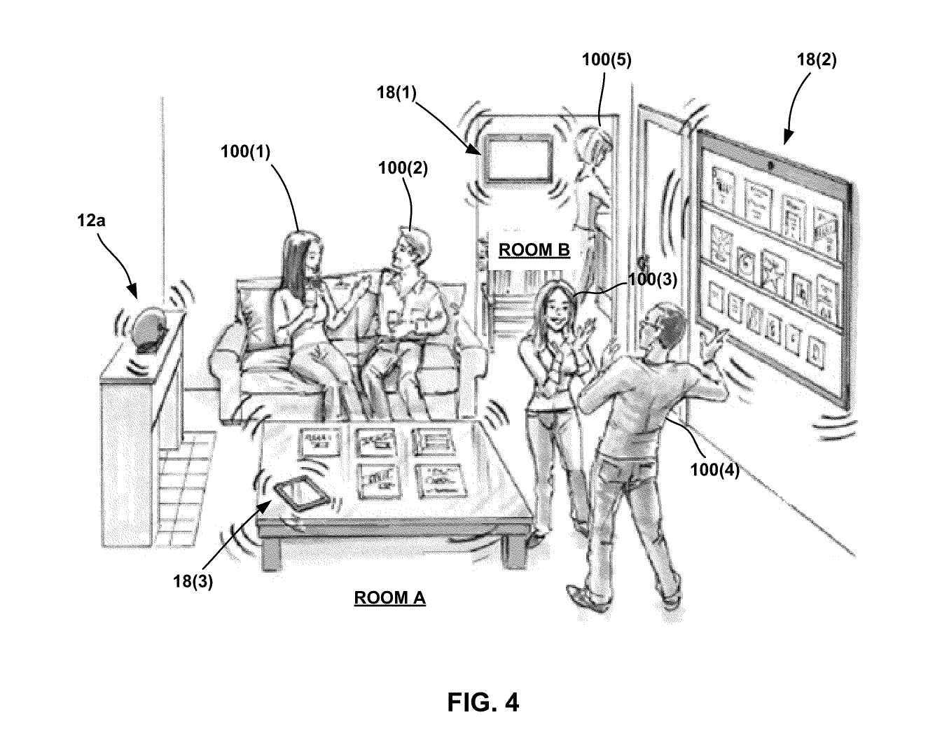

Turning now to FIG. 4, a depiction of an environment including a system 10 consistent with various embodiments of the present disclosure is generally illustrated. As shown, the environment generally consists of a first room (Room A) having users 100(1)-100(4) and a second room (Room B) having user 100(5). In the illustrated embodiment, a media delivery system 12a may be positioned within Room A and configured to communicate (e.g. transmit and receive signals) with at least one of the media devices 18(1)-18(3).

As previously described, the sensors (not shown) may be positioned in one or more desired locations throughout the environment. In one embodiment, for example, the sensors may be included within the respective media devices 18(1)-18(3). As such, sensors (e.g. camera and microphone) of media device 18(3) may be configured to capture images and voice data of users 100(1) and 100(2), as media device 18(3) is in close proximity to users 100(1) and 100(2). Similarly, sensors of media 18(2) may be configured to capture data related to users 100(3) and 100(4) due to the close proximity. As device 18(1) is in Room B with user 100(5), the sensors of device 18(1) may be configured to capture data related to room B and user 100(5).

Accordingly, the media delivery system 12a may be configured to identify contextual characteristics associated with the captured data from sensors of each of the media devices 18(1)-18(3). For example, the media delivery system 12a may be configured to identify contextual characteristics related to users 100(1) and 100(2), and in particular, determine the overall theme (topic) of their interaction (e.g. conversation) with one another. Likewise, the media delivery 12a system may be configured to identify the contextual characteristics related to the other users 100(3)-100(5) and overall themes. The media delivery system 12a may further search for media having content related to the overall themes for display on the associated devices 18(1)-18(3).

For example, users 100(1) and 100(2) may be discussing the latest gossip on a particular celebrity. As such, the media delivery system 12a may be configured to identify the topic of the conversation (e.g. celebrity gossip) based at least on speech recognition of the conversation. In turn, the media delivery system 12a may search a media source and identify media having content related to the celebrity gossip and transmit the relevant media content to device 18(3) for display. The relevant media content may include, for example, digital content from an online gossip magazine related to the celebrity or recent photos of the celebrity.

Likewise, users 100(3) and 100(4) may be discussing a recent cruise vacation. The media delivery system 12a may be configured to identify the topic of the conversation (e.g. cruise and/or destination) and search for and identify media having content related to the cruise and/or destination and transmit the relevant media content to device 18(2). Although in another room (room B) and apparently not engaged in discussion with other users, user 100(5) may still be presented with media content related to one or more contextual characteristics of room B and the user 100(5). For example, user 100(5) may be washing dishes and the contextual characteristics may correspond to this action. As such, the media delivery system 12a may be configured to identify media having content related to washing dishes (e.g. advertisement for dish detergent) and may transmit such media content to device 18(1) for presentation to the user 100(5).

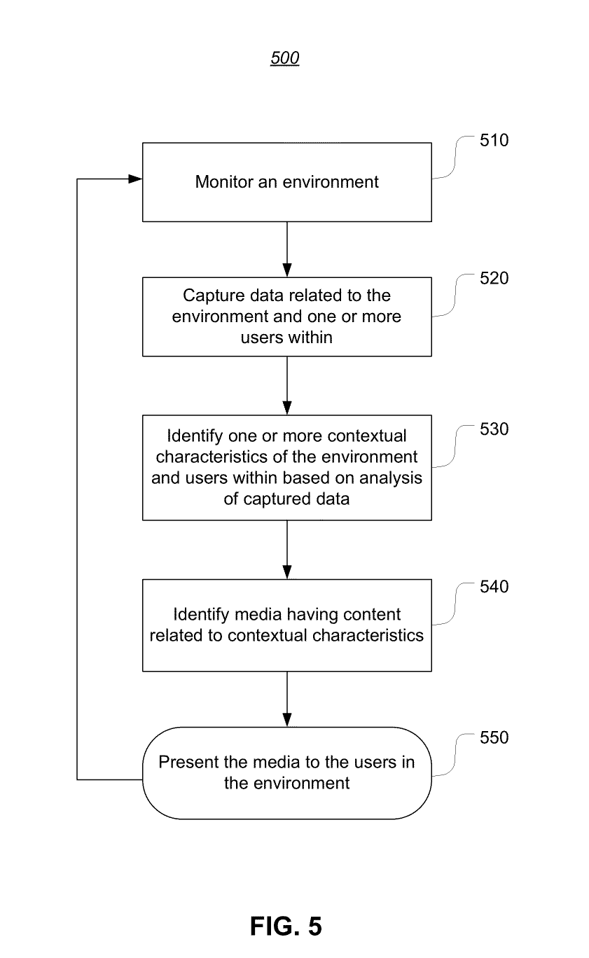

Turning now to FIG. 5, a flowchart of one embodiment of a method 500 for adaptive delivery of media consistent with the present disclosure is illustrated. The method 500 includes monitoring an environment (operation 510) and capturing data related to the environment and one or more users within the environment (520). Data may be captured by one of a plurality of sensors. The data may be captured by a variety of sensors configured to detect various characteristics of the environment and one or more users within. The sensors may include at least one camera and at least one microphone.

One or more contextual characteristics of the environment and the users within may be identified from the captured data (operation 530). In particular, recognition modules may receive data captured by associated sensors, wherein each of the recognition modules may analyze the captured data to determine one or more of the following contextual characteristics: identities of one or more of the users; physical motion, such as gestures, of the one or more users; identity of one or more objects in the environment; and subject matter of a conversation between one or more users.

The method 300 further includes identifying media having content related to the contextual characteristics (operation 540). For example, media, such as web content (e.g. news stories, photos, music, etc.) may be identified as having content relevant to one or more of the contextual characteristics. The relevant media content is presented to the users within the environment (operation 550).

While FIG. 5 illustrates method operations according various embodiments, it is to be understood that in any embodiment not all of these operations are necessary. Indeed, it is fully contemplated herein that in other embodiments of the present disclosure, the operations depicted in FIG. 5 may be combined in a manner not specifically shown in any of the drawings, but still fully consistent with the present disclosure. Thus, claims directed to features and/or operations that are not exactly shown in one drawing are deemed within the scope and content of the present disclosure.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present invention should not be limited by any of the above-described exemplary embodiments, but should be defined only in accordance with the following claims and their equivalents.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

According to one aspect, there is provided a system for adaptive delivery of media for presentation to one or more users in an environment. The system includes at least one sensor configured to capture data related to an environment and one or more users within the environment. The system further includes at least one recognition module configured to receive the captured data from the at least one sensor and identify one or more characteristics of the environment and the one or more users based on the data. The system further includes a media delivery system configured to receive the one or more identified characteristics from the at least one recognition module and access and identify media provided by a media source based on the one or more identified characteristics. The identified media has content related to the one or more identified characteristics. The system further includes at least one media device configured to receive relevant media content from the media delivery system and present the relevant media content to the one or more users within the environment.

Another example system includes the foregoing components and the at least one sensor is selected from the group consisting of a camera and a microphone. The camera is configured to capture one or more images of the environment and the one or more users within and the microphone is configured to capture sound of the environment, including voice data of the one or more users within.

Another example system includes the foregoing components and the at least one recognition module is configured to identify the one or more characteristics of the environment and the one or more users within based on the one or more images and the sound.

Another example system includes the foregoing components and the one or more characteristics are selected from the group consisting of identities of the one or more users, subject matter of communication between the one or more users, physical motion of the one or more users and objects identified within the environment.

Another example system includes the foregoing components and the at least one recognition module includes a user recognition module configured to receive and analyze the one or more images from the camera and the voice data from the microphone and identify user characteristics of the one or more users based on image and voice data analysis.

Another example system includes the foregoing components and the user recognition module includes a face detection module configured to identify a face and one or more facial characteristics of the face of a user in the one or more images and a voice recognition module configured to identify a voice and one or more voice characteristics of a user in the voice data. The face detection and voice recognition modules are configured to identify a user model stored in a user database having data corresponding to the facial and voice characteristics.

Another example system includes the foregoing components and the at least one recognition module includes a speech recognition module configured to receive and analyze voice data from the microphone and identify subject matter of the voice data.

Another example system includes the foregoing components and the media delivery system includes a context management module configured to receive and analyze the one or more characteristics from the at least one recognition module and determine an overall theme corresponding to an activity of the one or more users within the environment based, at least in part, on the one or more characteristics.

Another example system includes the foregoing components and the context management module is further configured to access and search the media source for media having content related to the overall theme and transmit data related to the relevant media content to the at least one media device for presentation to the one or more users.

Another example system includes the foregoing components and the context management module is configured to store data related to the one or more characteristics in associated profiles of a context database and further append the associated profiles with indexes to the relevant media content.

According to another aspect, there is provided an apparatus for adaptive delivery of media for presentation to one or more users in an environment. The apparatus includes a context management module configured to receive one or more characteristics of an environment and one or more users within the environment from at least one recognition module and identify media from a media source based on the one or more characteristics. The identified media has content related to the one or more characteristics, and provide the relevant media content to a media device for presentation to the one or more users within the environment.

Another example system includes the foregoing components and the context management module includes a theme determination module configured to analyze the one or more characteristics and determine an overall theme corresponding to an activity of the one or more users within the environment based, at least in part, on the one or more characteristics.

Another example system includes the foregoing components and the context management module further includes a search module configured to search the media source for media having content related to at least the overall theme established by the theme determination module.

Another example system includes the foregoing components and the context management module is configured to store data related to the one or more characteristics in associated profiles of a context database and further append the associated profiles with indexes to the relevant media content.

Another example system includes the foregoing components and the one or more characteristics are selected from the group consisting of identities of the one or more users, subject matter of communication between the one or more users, physical motion of the one or more users and objects identified within the environment.

According to another aspect there is provided at least one computer accessible medium including instructions stored thereon. When executed by one or more processors, the instructions may cause a computer system to perform operations for adaptive delivery of media for presentation to one or more users in an environment. The operations include receiving data captured by at least one sensor, identifying one or more characteristics of an environment and one or more users within the environment based on the data, identifying media from a media source based on the one or more characteristics, the identified media having content related to the one or more characteristics and transmitting relevant media content to at least one media device for presentation to the one or more users in the environment.

Another example computer accessible medium includes the foregoing operations and the one or more characteristics are selected from the group consisting of identities of the one or more users, subject matter of communication between the one or more users, physical motion of the one or more users and objects identified within the environment.

Another example computer accessible medium includes the foregoing operations and the data is selected from the group consisting of one or more images of the environment and the one or more users within the environment and sound data of the environment and the one or more users within the environment.

Another example computer accessible medium includes the foregoing operations and further includes analyzing the one or more images and the sound data and identifying user characteristics of the one or more users based on the image and sound data analysis.

Another example computer accessible medium includes the foregoing operations and the analyzing the one or more images and the sound data includes identifying a face and one or more facial characteristics of the face of a user in the one or more images and identifying a voice and one or more voice characteristics of a user in the sound data.

Another example computer accessible medium includes the foregoing operations and further includes analyzing the sound data and identifying subject matter of the sound data.

Another example computer accessible medium includes the foregoing operations and further includes transmitting data related to the one or more characteristics to associated profiles of a context database and appending the associated profiles of the context database with indexes related to the relevant media content.

According to another aspect there is provided a method for adaptive delivery of media for presentation to one or more users in an environment. The method includes receiving, by at least one recognition module, data captured by at least one sensor, identifying, by the at least one recognition module, one or more characteristics of an environment and one or more users within the environment based on the data, receiving, by a media delivery system, the identified one or more characteristics from the at least one recognition module, identifying, by the media delivery system, media from a media based on the one or more characteristics, the identified media having content related to the one or more characteristics, transmitting, by the media delivery system, relevant media content to at least one media device and presenting, by the at least one media device, the relevant media content to the one or more users in the environment.

Another example method includes the foregoing operations and the at least one sensor is selected from the group consisting of a camera and a microphone. The camera is configured to capture one or more images of the environment and the one or more users within and the microphone is configured to capture sound of the environment, including voice data of the one or more users within.

Another example method includes the foregoing operations and the at least one recognition module is configured to identify the one or more characteristics of the environment and the one or more users within based on the one or more images and the sound.

Another example method includes the foregoing operations and the one or more characteristics are selected from the group consisting of identities of the one or more users, subject matter of communication between the one or more users, physical motion of the one or more users and objects identified within the environment.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. A system for adaptive delivery of media for presentation to one or more users in an environment, said system comprising:
at least one sensor configured to capture data related to an environment and one or more users within said environment;
at least one recognition module configured to receive said captured data from said at least one sensor and identify one or more characteristics of said environment and said one or more users based on said data;
a media delivery system configured to receive said one or more identified characteristics from said at least one recognition module and access and identify media provided by a media source based on said one or more identified characteristics, said identified media having content related to said one or more identified characteristics; and
at least one media device configured to receive relevant media content from said media delivery system and present said relevant media content to said one or more users within said environment.

2. The system of claim 1, wherein said at least one sensor is selected from the group consisting of a camera and a microphone, wherein said camera is configured to capture one or more images of said environment and said one or more users within and said microphone is configured to capture sound of the environment, including voice data of said one or more users within.

3. The system of claim 2, wherein said at least one recognition module is configured to identify said one or more characteristics of said environment and said one or more users within based on said one or more images and said sound.

4. The system of claim 3, wherein said one or more characteristics are selected from the group consisting of identities of said one or more users, subject matter of communication between said one or more users, physical motion of said one or more users and objects identified within said environment.

5. The system of claim 4, wherein said at least one recognition module comprises a user recognition module configured to receive and analyze said one or more images from said camera and said voice data from said microphone and identify user characteristics of said one or more users based on image and voice data analysis.

6. The system of claim 5, wherein said user recognition module comprises:
a face detection module configured to identify a face and one or more facial characteristics of said face of a user in said one or more images; and
a voice recognition module configured to identify a voice and one or more voice characteristics of a user in said voice data;
wherein said face detection and voice recognition modules are configured to identify a user model stored in a user database having data corresponding to said facial and voice characteristics.

7. The system of claim 4, wherein said at least one recognition module comprises a speech recognition module configured to receive and analyze voice data from said microphone and identify subject matter of said voice data.

8. The system of claim 1, wherein said media delivery system comprises a context management module configured to receive and analyze said one or more characteristics from said at least one recognition module and determine an overall theme corresponding to an activity of said one or more users within said environment based, at least in part, on said one or more characteristics.

9. The system of claim 8, wherein said context management module is further configured to access and search said media source for media having content related to said overall theme and transmit data related to said relevant media content to said at least one media device for presentation to said one or more users.

10. The system of claim 9, wherein said context management module is configured to store data related to said one or more characteristics in associated profiles of a context database and further append said associated profiles with indexes to said relevant media content.

11. An apparatus for adaptive delivery of media for presentation to one or more users in an environment, said apparatus comprising:
a context management module configured to receive one or more characteristics of an environment and one or more users within said environment from at least one recognition module and identify media from a media source based on said one or more characteristics, said identified media having content related to said one or more characteristics, and provide said relevant media content to a media device for presentation to said one or more users within said environment.

12. The apparatus of claim 11, wherein said context management module comprises a theme determination module configured to analyze said one or more characteristics and determine an overall theme corresponding to an activity of said one or more users within said environment based, at least in part, on said one or more characteristics.

13. The apparatus of claim 12, wherein said context management module further comprises a search module configured to search said media source for media having content related to at least said overall theme established by said theme determination module.

14. The apparatus of claim 11, wherein said context management module is configured to store data related to said one or more characteristics in associated profiles of a context database and further append said associated profiles with indexes to said relevant media content.

15. The apparatus of claim 11, wherein said one or more characteristics are selected from the group consisting of identities of said one or more users, subject matter of communication between said one or more users, physical motion of said one or more users and objects identified within said environment.

16. At least one computer accessible medium storing instructions which, when executed by a machine, cause the machine to perform operations for adaptive delivery of media for presentation to one or more users in an environment, said operations comprising:
receiving data captured by at least one sensor;
identifying one or more characteristics of an environment and one or more users within said environment based on said data;
identifying media from a media source based on said one or more characteristics, said identified media having content related to said one or more characteristics;
transmitting relevant media content to at least one media device for presentation to said one or more users in said environment.

17. The computer accessible medium of claim 16, wherein said one or more characteristics are selected from the group consisting of identities of said one or more users, subject matter of communication between said one or more users, physical motion of said one or more users and objects identified within said environment.

18. The computer accessible medium of claim 16, wherein said data is selected from the group consisting of one or more images of said environment and said one or more users within said environment and sound data of said environment and said one or more users within said environment.

19. The computer accessible medium of claim 18, further comprising:
analyzing said one or more images and said sound data; and
identifying user characteristics of said one or more users based on said image and sound data analysis.

20. The computer accessible medium of claim 19, wherein said analyzing said one or more images and said sound data comprises:
identifying a face and one or more facial characteristics of said face of a user in said one or more images; and
identifying a voice and one or more voice characteristics of a user in said sound data.

21. The computer accessible medium of claim 18, further comprising:
analyzing said sound data; and
identifying subject matter of said sound data.

22. The computer accessible medium of claim 16, further comprising:
transmitting data related to said one or more characteristics to associated profiles of a context database; and
appending said associated profiles of said context database with indexes related to said relevant media content.

23. A method for adaptive delivery of media for presentation to one or more users in an environment, said method comprising:
receiving, by at least one recognition module, data captured by at least one sensor;
identifying, by said at least one recognition module, one or more characteristics of an environment and one or more users within said environment based on said data;
receiving, by a media delivery system, said identified one or more characteristics from said at least one recognition module;
identifying, by said media delivery system, media from a media based on said one or more characteristics, said identified media having content related to said one or more characteristics;
transmitting, by said media delivery system, relevant media content to at least one media device; and
presenting, by said at least one media device, said relevant media content to said one or more users in said environment.

24. The method of claim 23, wherein said at least one sensor is selected from the group consisting of a camera and a microphone, wherein said camera is configured to capture one or more images of said environment and said one or more users within and said microphone is configured to capture sound of the environment, including voice data of said one or more users within.

25. The method of claim 24, wherein said at least one recognition module is configured to identify said one or more characteristics of said environment and said one or more users within based on said one or more images and said sound.

26. The method of claim 23, wherein said one or more characteristics are selected from the group consisting of identities of said one or more users, subject matter of communication between said one or more users, physical motion of said one or more users and objects identified within said environment.
